(19) United States
(12) Patent Application Publication
(10) Pub. No.: US 2013/0097872 A1
(43) Pub. Date: Apr. 25, 2013

(54) Razor Cartridge With Improved Guard

(71) Applicant: Eveready Battery Company Inc., St. Louis, MO (US)

(72) Inventor: Alan Blatter, Hamden, CT (US)

(73) Assignee: EVEREADY BATTERY COMPANY INC., St Louis, MO (US)

(21) Appl. No.: 13/648,337

(22) Filed: Oct. 10, 2012

Related U.S. Application Data
(60) Provisional application No. 61/551,024, filed on Oct. 25, 2011.

(51) Int. Cl. B26B 21/22

(52) U.S. Cl. 30/50

(57) ABSTRACT

A razor cartridge has a housing having a guard and a cap and a plurality of parallel blades supported by the housing between the guard and the cap, each blade having a respective cutting edge. The guard includes a first and a second group of rows of elongated, elastomeric fins, each group being arranged generally parallel to the cutting edges and positioned to engage a user's skin, the second group being closer to the blades than the first group. The tips of the fins of the first group define a surface and an extension of the surface intersects the outer surface of the outermost fin of the second group to define a step between this intersection and a plane parallel to a plane through the cutting edges and tangential to the tip of outermost fin in a direction away from the guard.

### CROSS REFERENCE TO RELATED APPLICATIONS

This application claims the benefit of U.S. provisional patent application serial number 61/551,024, filed Oct. 25, 2011, the content of which is incorporated herein in its entirety for reference.

### TECHNICAL FIELD

The present subject matter relates to a safety razor and especially to a razor cartridge therefor with an improved guard.

### BACKGROUND

Many modern wet shaving razors, also known as safety razors, comprise a handle and a (razor) cartridge joined to handle. The razor may be disposable where the handle and cartridge together are disposed of after use. Alternatively, the razor may be in the form of a so-called system that comprises a longer term use handle that is reused and a removable and disposable cartridge that is disposed after use and can be replaced with a new cartridge. The cartridge includes a housing having razor blade(s) with sharpened cutting edge(s) typically disposed between a guard forward of the cutting edges and a cap aft of the cutting edges.

In U.S. Pat. No. 5,191,712 a razor cartridge is disclosed having a guard surface with a single array of closely spaced projections which, in use, produce a pleasant tactile sensation tending to reduce shaving discomfort. The projections can include an array of flexible molded fins comprising a plurality of rows extending generally parallel with the blade edge(s) of the razor cartridge.

In U.S. Pat. No. 6,651,342 a razor cartridge is disclosed having a guard that includes two groups of rows of elongated, elastomeric fins arranged generally parallel to the cutting edges of the blades. The first group of fins has tips with increasing elevation with respect to a plane through the cutting edges, and the second group of fins has tips of generally uniform position relative to the plane.

### SUMMARY

The present disclosure has for its objective to eliminate, or at least substantially alleviate the limitations of the prior art by providing a razor cartridge having a housing with a guard at the front of the housing and a cap at the rear of the housing. A plurality of parallel blades, each having a respective cutting edge is supported by the housing between the guard and the cap. The guard includes a first and a second group of rows of elongated, elastomeric fins, each group being arranged generally parallel to the cutting edges and positioned to engage a user's skin, the second group being closer to the blades than the first group. Tips of the fins of the first group define a surface tangential to the tips and an extension of this surface intersects the outer surface of the body of the outermost fin of the second group of fins such that a step is created between this intersection and a plane parallel to a plane through the tips of the blades and tangential to the tip of this outermost fin in a direction away from the guard. Preferably the step is at least 0.3 mm high.

In some aspects of the present disclosure the tips of the first group of fins have an increasing elevation with respect to a plane through the cutting edges and in some aspects the tips of the second group of fins have one of a uniform elevation and a decreasing elevation with respect to the plane through the cutting edges.

In some aspects of the present disclosure the tips of the first group of fins are all below the plane through the cutting edges and in some aspects the tips of the second group of fins are all above the plane through the cutting edges.

In some aspects of the present disclosure the fins of the second group of fins are arranged parallel to the cutting edges and in some aspects the fins of the first group of fins are arranged in one of parallel to the cutting edges and at an acute angle to the cutting edges.

In some aspects of the present disclosure the first group of fins extends from a first substrate and the second group of fins extends from a second substrate. The first substrate and the second substrate can be integrally formed or can be separately formed. The material of the first group of fins can be different (e.g. more flexible or more or less hard) to the material of the second group of fins.

The provision of the step between the first and second groups of fins provides a disclocation or sudden variation in topography of a theoretical outer surface of the guard defined by the tips of both groups of fins. This disclocation provides shaving benefits, e.g. enhanced comfort and closeness, especially when used with a razor cartridge including a lubrication box such as that disclosed in commonly assigned U.S. patent application Ser. No. 12/909,005, published as U.S. 2011/0099815. Without being limited by theory, Applicants believe that the frictional and sensory properties of the present guard complement the enhanced lubrication provided by this lubrication box. In normal use, the dislocation exposes the first fin of the second group of fins to the user's skin and permits this second group to provide improved skin flow. The present guard can also be beneficially used with other types of razor cartridge such as those having extruded or molded shaving aid members comprising a water soluble polymer and a water insoluble polymer.

### BRIEF DESCRIPTION OF THE DRAWINGS

Reference is made to the attached drawings, wherein elements having the same reference numeral designations represent like elements throughout, and wherein:

FIG. 1 is a perspective view of an embodiment of a razor cartridge;

FIG. 2 is a partial sectional view of the cartridge of FIG. 1;

FIG. 2A is an enlarged portion of FIG. 2;

FIG. 3 is an enlarged portion of a partial sectional view of another embodiment of a razor cartridge;

FIG. 4 is an enlarged portion of a partial sectional view of a further embodiment of a razor cartridge;

FIG. 5 is an enlarged portion of a partial sectional view of a still further embodiment of a razor cartridge; and

FIG. 6 is a perspective view of another embodiment of a razor cartridge.

### DETAILED DESCRIPTION

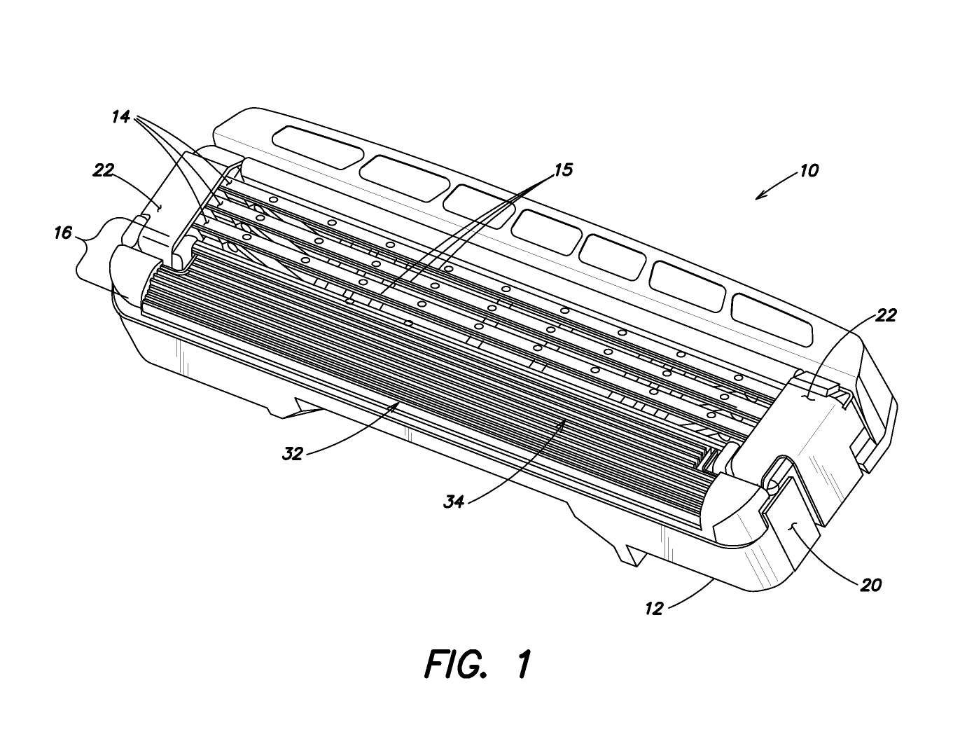

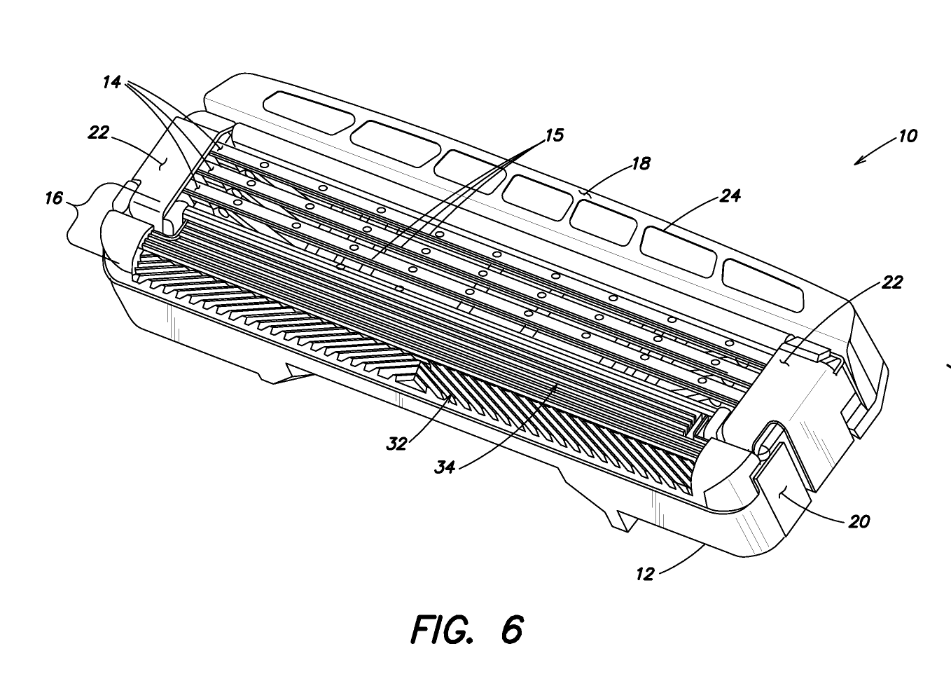

Referring now to the drawings and in particular to FIGS. 1 and 6, a razor cartridge 10 adapted to be mounted (e.g. pivotally mounted) to a handle of a safety razor is shown. The cartridge includes a housing 12, which carries a plurality (e.g. three, four, five or more) of blades 14 having respective cutting edges 15, a guard 16 and a cap 18.

The housing 12 is preferably manufactured from a generally rigid thermoplastic polymer such as acrylonitrile butadiene styrene (ABS). A suitable ABS material is designated HI-10, manufactured by BASF. This specific ABS is selected for properties that include: good dimensional stability at molding, good resistance to chemicals encountered in typical use of the razor cartridge and good impact strength. One of skill in the art will understand other suitable thermoplastic polymeric molding materials may also be selected, such as polyphenylene oxide (PPO) and also blends of materials. Preferably, the housing is manufactured by an injection molding process, more preferably by a multi-shot injection molding which permits an elastomeric guard member 30 (discussed later in the present application) to be suitably formed and joined to the housing. The elastomeric member preferably has a Shore A hardness in the range 30 to 60. Preferably the material of the elastomeric member is selected from the material family designated THERMOPLAST manufactured by KRAIBURG such as grade TF4ACC. This specific material is selected for properties that include good chemical resistance in normal use and an ability to chemically bond to the ABS housing, thus reducing the need for additional joining methods such as gluing or welding. This specific material has a hardness 42 defined on the Shore A scale. As also will be discussed later in the present application materials having different hardness values, e.g. 52 Shore A can beneficially be selected. One of skill in the art will understand the elastomeric member can be made from other suitable thermoplastic elastomers (TPEs) or rubbers, e.g. silicones, natural rubber, butyl rubber, nitrile rubber, styrene butadiene rubber, styrene butadiene styrene (SBS) TPEs, styrene ethylene butadiene styrene (SEBS) TPEs (e.g., KRATON), polyester TPEs (e.g., HYTREL), polyamide TPEs (PEBAX), polyurethane TPEs, polyolefin based TPEs, and blends of any of these TPEs (e.g., polyester/SEBS blend).

The blades 14 can be individually or as a group mounted on one or more supports, e.g. a bent metal support, which support can be guided in slots of the inner face of each end wall 20 of the housing. The blades on respective supports can be permitted to slide in their respective slots under forces encountered during shaving. One or more clips 22 retain each end of the blades on their respective supports in the housing.

The cap 18 can include a lubrication box 24 such as that disclosed in commonly assigned U.S. patent application Ser. No. 12/909,005, published as U.S. 2011/0099815, incorporated herein in its entirety for reference. Other so-called lubrication members also known as shaving aid or comfort strips can be provided such as injection molded or extruded mixtures of water soluble and water insoluble polymers.

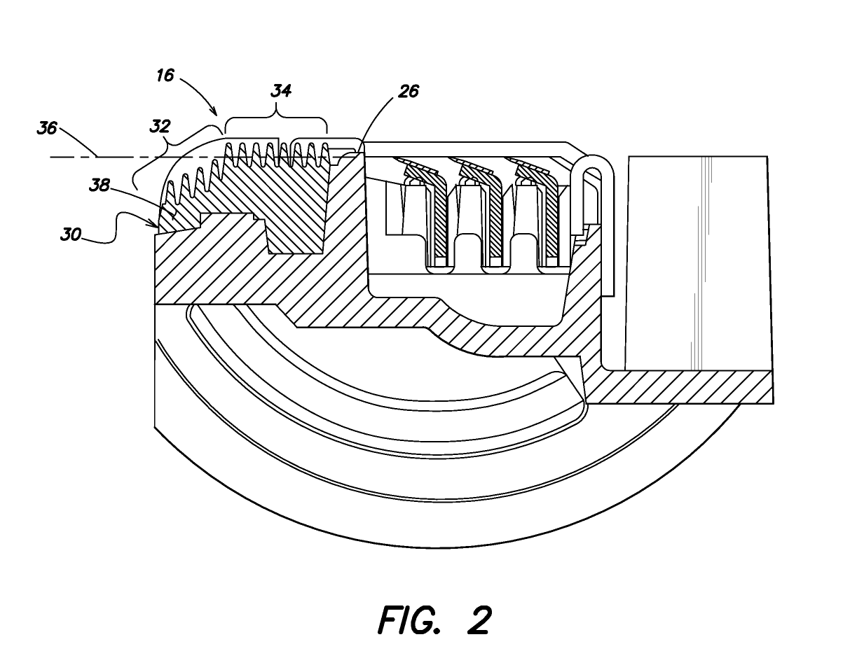

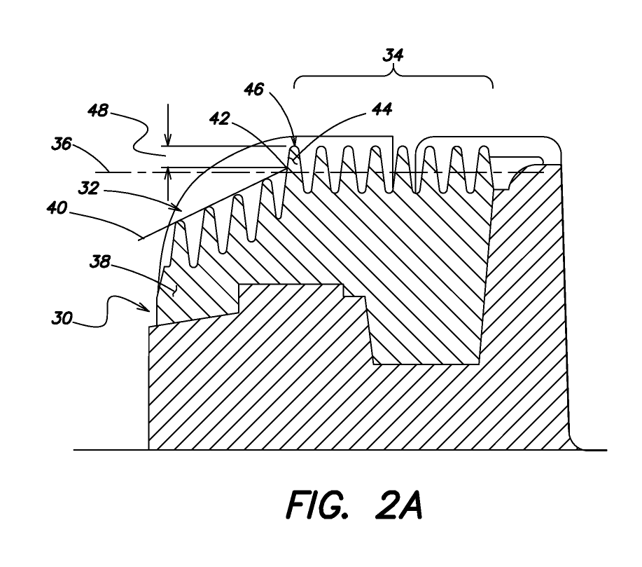

Referring additionally to FIGS. 2 and 2A, guard 16 includes elastomeric member 30 and can include backstop 26. Elastomeric member 30 has two groups 32, 34 of resilient fins. Each group of fins preferably has at least four fins. The first group of fins 32 is spaced further from the blades than the second group of blades 34. The tips of the first group of fins increase in elevation, e.g. uniformly increase in elevation with respect to plane 36 through the cutting edges 15 of the blades 14, i.e. the tip of the fin closest to the blades is spaced closer to the plane 36 than the tip of any other fin of this first group. The tips of the fins of the first group of fins are below, i.e. on the housing side of plane 36. Alternatively, the tips of one or more fins of the first group of fins, e.g. the fin closest to the blades, can be above the plane 36.

Both groups of fins extend from a single substrate 38. As depicted, the fins of both groups are tapered, preferably at about 10-14 degrees included angle, to enhance removal of the fins from their respective mold cavity after molding. The fins of both groups of fins preferably have rounded tips. The fins of either group are at least about 0.5 mm high, spaced at least about 0.3 mm from a next adjacent fin of their respective group and have a width defined at the respective root at least about 0.2 mm.

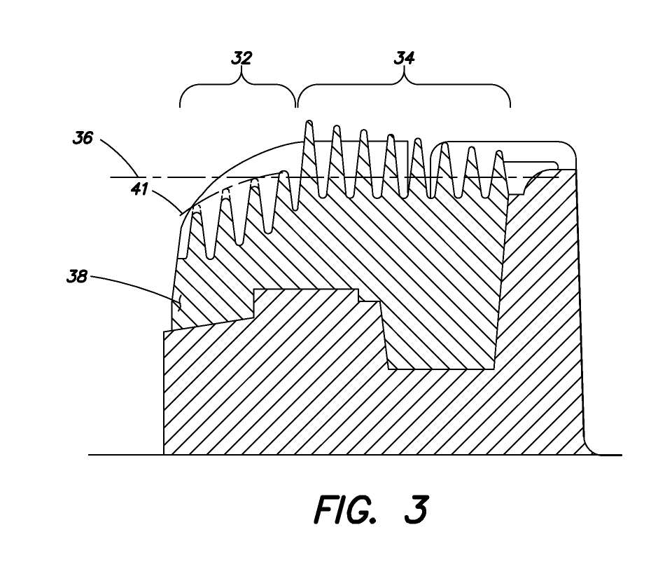

The tips of the second group of fins are above and uniformly spaced about 0.3 mm from the plane 36. Alternatively, as also depicted in FIG. 3, the tips of the fins of the second group decrease, e.g. uniformly decrease in elevation with respect to plane 36, i.e. the tip of the fin closest to the blades is spaced closer to the plane 36 than the tip of any other fin of this group.

Referring back to FIG. 2A, a surface 40 can be constructed tangential to the tips of the fins of the first group. The surface can be planar or be non-planar, e.g. the surface can define a gentle curve 41 as depicted in FIG. 3. A planar surface can define an angle up to about 25 degrees to plane 36. An extension 42 of this surface intersects the outer surface of the body 44 of the outermost fin 46 of the second group of fins such that a step 48 is created between this intersection and a plane parallel to plane 36 and tangential to the tip of outermost fin 46 in a direction away from the guard. Preferably the step is at least about 0.3 mm high.

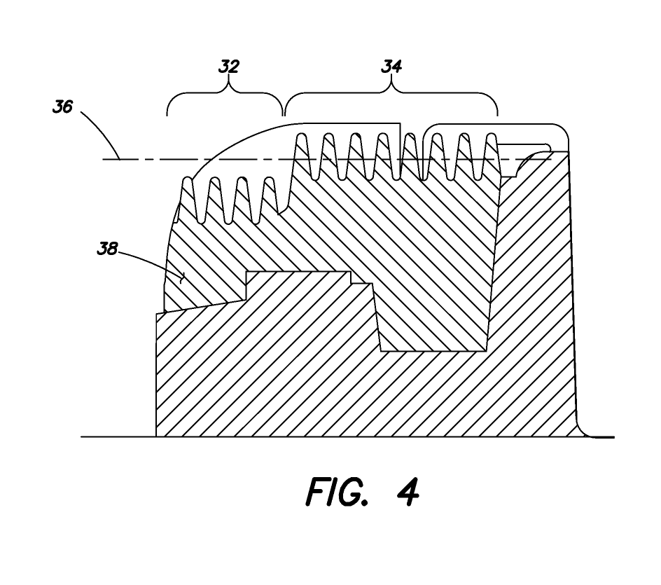

Referring now to FIG. 4, the tips of the fins of the first group of fins can be arranged parallel to the plane 36, i.e. the tips of the fins are uniformly spaced from plane 36.

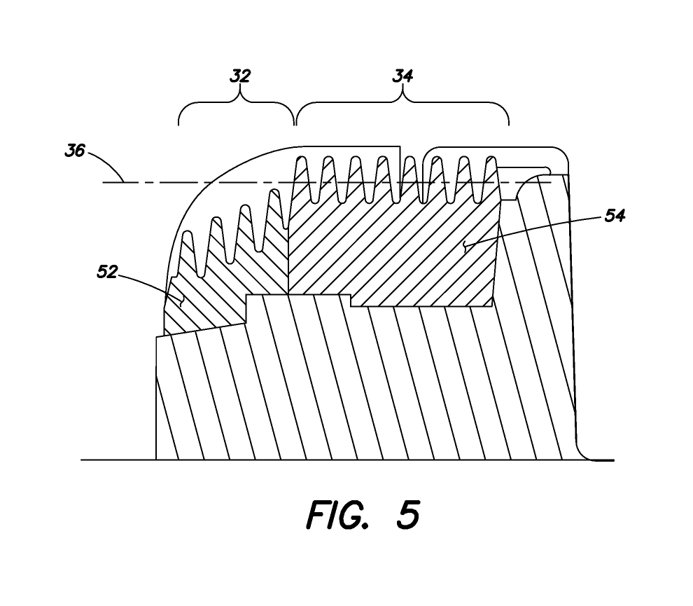

Referring now to FIG. 5, the first group of fins 32 can extend from and be integrally formed with a first substrate 52 and the second group of fins 34 can extend from a second substrate 54. Unlike the arrangement of FIG. 3, the first substrate is separate from the second substrate. The first group of fins 32 and their integral substrate 52 can be formed from a first material and the second group of fins 34 and their integral substrate 54 can be formed from a second material. For additional benefits, the first material and the second material can be different. For example the first material can be more flexible or softer (e.g. can have a lower Shore A hardness value, e.g. 42 Shore A as previously mentioned) than the second material which can be e.g. 52 Shore A also as previously mentioned. This can provide additional skin flow benefits wherein, in use, the first group of fins prepare the skin (e.g. pre-tension and/or pre-stimulate) in advance of the second group of fins. Alternatively the first group of fins can be harder than the second group of fins.

As depicted in FIG. 1, the second group of fins 34 is arranged parallel to the cutting edges 15 of the blades 14 and the fins of this group are also arranged parallel to the cutting edges. As depicted in FIG. 6, the first group of fins is also arranged parallel to the cutting edges. In FIG. 6 the fins of this group are arranged at an angle to the cutting edges. In particular this first group of fins can comprise two sub-groups as depicted, each sub-group being arranged at an acute angle to the cutting edges, e.g. at about 20 degrees, and as a mirror image of each other. In this manner the first group of fins can additionally provide a “snow plough” effect to beneficially distribute any shaving preparation (e.g. shave foam or shave cream etc.) on the user's skin in advance of the second group of fins. These and other benefits for laterally stretching the user's skin in advance of the cutting edges are disclosed in U.S. Pat. No. 5,689,883 incorporated herein for reference in its entirety. Alternatively, as depicted in FIG. 1, the fins of the first group 32 can be arranged parallel to the cutting edges 15.

In use, the provision of the outward step 48 provides a dislocation in the theoretical outer surface of the elastomeric member of the guard as a whole. Each group of fins 32 and 34 tends to individually tension and/or stimulate the skin in front of the blades, tending to improve comfort and closeness. The step or dislocation exposes the first fin of the second group of fins enabling the second group to provide enhanced skin flow and the elastomeric member of the guard as a whole to provide benefits as mentioned, especially when used with a cartridge including a lubrication box as previously mentioned. The present guard can also be beneficially used with other types of razor cartridge such as those having extruded or molded shaving aid members comprising a water soluble polymer and a water insoluble polymer.

Although the invention has been described and illustrated with reference to specific illustrative embodiments thereof, it is not intended that the invention be limited to those illustrative embodiments. Those skilled in the art will recognize that variations and modifications can be made without departing from the true scope of the invention as defined by the claims that follow. For instance, features disclosed in connection with any one embodiment can be used alone or in combination with each feature of the respective other embodiments. It is intended by the following claims to claim any and all applications, modifications and variations that fall within the true scope of the present teachings.

What is claimed is:

1. A razor cartridge comprising:
a housing having a guard and a cap; and
a plurality of parallel blades supported by the housing between the guard and the cap, each having a respective cutting edge and defining a plane through the cutting edges;
wherein the guard includes a first and a second group of rows of elongated, elastomeric fins, each group being arranged generally parallel to the cutting edges and positioned to engage a user's skin, the second group being closer to the blades than the first group;
wherein tips of the fins of the first group define a surface tangential to the tips and an extension of the surface intersects an outer surface of an outermost fin of the second group of fins to define a step between the intersection and a plane tangential to an apex of the outermost fin of the second group of fins and parallel to the plane through the cutting edges in a direction away from the guard.

2. The razor cartridge of claim 1, wherein the tips of the first group of fins have an increasing elevation with respect to the plane through the cutting edges.

3. The razor cartridge of claim 1, wherein the tips of the second group of fins have one of a uniform elevation and a decreasing elevation with respect to the plane through the cutting edges.

4. The razor cartridge of claim 1, wherein the tips of the first group of fins are all below the plane through the cutting edges.

5. The razor cartridge of claim 1, wherein the surface tangential to the tips of the fins of the first group is one of planar and defines a gentle curve.

6. The razor cartridge of claim 1, wherein the tips of the second group of fins are all above the plane through the cutting edges.

7. The razor cartridge of claim 1, wherein the fins of the second group of fins are arranged parallel to the cutting edges.

8. The razor cartridge of claim 1, wherein the fins of the first group of fins are arranged parallel to the cutting edges.

9. The razor cartridge of claim 1, wherein the fins of the first group of fins are arranged at an acute angle to the cutting edges.

10. The razor cartridge of claim 1, wherein the first group of fins extends from a first substrate and the second group of fins extends from a second substrate.

11. The razor cartridge of claim 10, wherein the first substrate and the second substrate are integrally formed.

12. The razor cartridge of claim 1, wherein the step is at least 0.3 mm high.

13. The razor cartridge of claim 1, wherein the first group of fins comprises a first material and the second group of fins comprises a second material and the first material is different to the second material.

14. The razor cartridge of claim 13, wherein the first material has a lower hardness defined on a Shore A scale than the second material.
